(19) United States
(12) Patent Application Publication
(10) Pub. No.: US 2026/0233704 A1
(43) Pub. Date: Aug. 13, 2026

(54) WIPER CONTROL DEVICE AND WIPER CONTROL METHOD

(71) Applicant: Nissan Motor Co., Ltd., Kanagawa (JP)

(72) Inventors: Shunsuke Maruo, Kanagawa (JP); Hiroshi Ozawa, Kanagawa (JP); Yuki Kinoshita, Kanagawa (JP)

(73) Assignee: Nissan Motor Co., Ltd., Kanagawa (JP)

(21) Appl. No.: 19/160,754

(22) PCT Filed: Mar. 1, 2023
(86) PCT No.: PCT/JP2023/007622

§ 371 Date: Aug. 28, 2025

(51) Int. Cl. B60S 1/08; B60S 1/58

(52) U.S. Cl. CPC B60S 1/0807; B60S 1/0859; B60S 1/583

(57) ABSTRACT

A wiper control device 10 determines whether water droplets are attached on a window glass or not based on window information, identifies an amount of the water droplets from the window information, operates a count of times a driver looks in an inside rear view mirror based on line of sight information, sets a count threshold corresponding to the amount of the water droplets, and outputs a control command to drive a rear wiper when the water droplets are determined to be attached on the window glass, and the operated count of looks is equal to or more than the count threshold.

### TECHNICAL FIELD

The present invention relates to a wiper control device and a wiper control method.

### BACKGROUND ART

There has been conventionally known a vehicle wiper device that automatically operates a rear wiper (for example, see Patent Document 1). The vehicle wiper device described in Patent Document 1 includes a water droplet detecting device that detects water droplets on a rear window glass, a driver monitor camera that monitors a driver, a control device, and a rear wiper driving device that drives a rear wiper. The control device determines whether water droplets are present on the rear window glass or not, determines whether a line of sight of the driver has moved to a rear view mirror or not, and outputs a signal that causes the rear wiper driving device to drive the rear wiper when the water droplets are determined to be present on the rear window glass and the line of sight of the driver is determined to have moved to the rear view mirror.

### PRIOR ART DOCUMENT

### Patent Document

Patent Document 1: JP 2021-062791 A

### SUMMARY OF INVENTION

### Problems to Be Solved by Invention

However, the vehicle wiper device described in Patent Document 1 has a problem that the rear wiper is driven against the intention of the driver, because the rear wiper operates if the driver sees the rear view mirror even when the amount of the water droplets attached on the rear window glass is small.

An object to be achieved by the present invention is to provide a wiper control device and a wiper control method that allow for driving of a rear wiper in line with an intention of a driver.

### Means for Solving Problems

The present invention solves the above-described problem by determining whether water droplets are attached on a window glass or not based on window information. identifying an amount of the water droplets from the window information, operating a count of times a driver looks in an inside rear view mirror based on line of sight information, setting a count threshold corresponding to the amount of the water droplets, and outputting a control command to drive a rear wiper when the water droplets are determined to be attached on the window glass, and the operated count is equal to or more than the count threshold.

### Effects of Invention

The present invention allows for driving of a rear wiper in line with an intention of a driver.

### BRIEF DESCRIPTION OF DRAWINGS

FIG. 1 is a block diagram of a wiper control system including a wiper control device according to an embodiment of the present invention.

FIG. 2 is a schematic view for describing a method of predicting a moving destination of a line of sight of a driver.

FIG. 3 is a flowchart showing an exemplary control procedure that executes a wiper control method according to the embodiment of the present invention.

FIG. 4 is flowchart showing an exemplary control procedure that executes a wiper control method according to a modification of the embodiment of the present invention.

### MODE FOR CARRYING OUT THE INVENTION

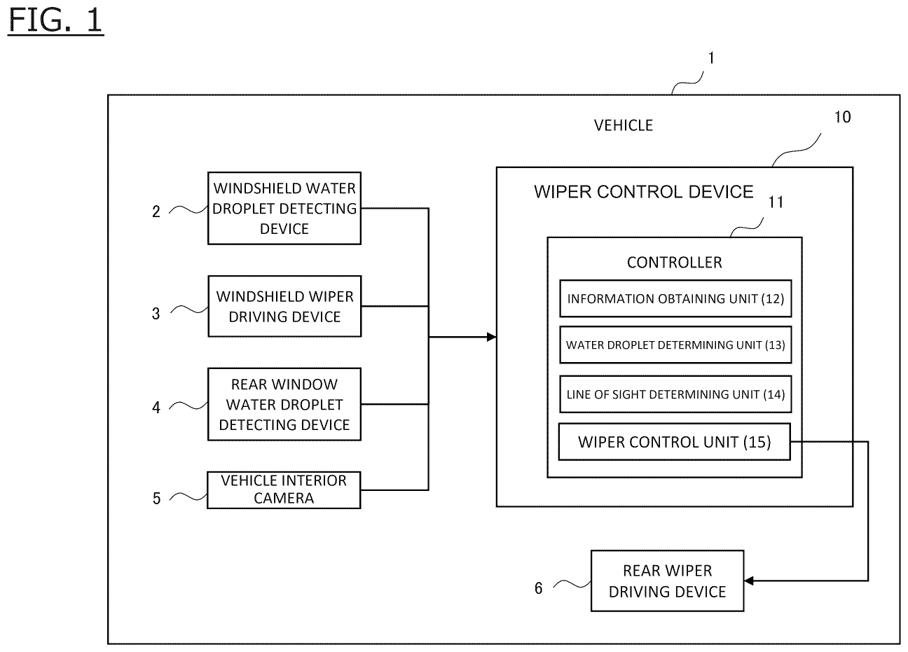

The following describes an embodiment of the present invention on the basis of the drawings. FIG. 1 is a block diagram of a wiper control system including a wiper control device 10 according to the embodiment. As illustrated in FIG. 1, the wiper control system is disposed in a vehicle 1, and includes a windshield water droplet detecting device 2, a windshield wiper driving device 3, a rear window water droplet detecting device 4, a vehicle interior camera 5, a rear wiper driving device 6, and the wiper control device 10. Each configuration included in the wiper control system transmits and receives information to and from one another via a vehicle-mounted network, such as CAN. The wiper control device 10 detects water droplets attached on a window glass, detects an action of a driver looking in an inside rear view mirror from a line of sight of the driver in a vehicle interior, determines that the water droplets are attached on the window glass, and, when the number of times the driver looks in the inside rear view mirror is equal to or more than multiple times, automatically drives the rear wiper.

The windshield water droplet detecting device 2 is a water droplet sensor installed on a windshield (a windshield glass). The windshield wiper driving device 3 includes an actuator for driving windshield wipers. The rear window (rear window glass) water droplet detecting device 4 is a water droplet sensor installed on a rear window (rear window glass). The vehicle interior camera 5 is a camera used for detecting a line of sight of a driver, and captures images of eyes of the driver. The vehicle interior camera 5 is an infrared (IR) camera, a camera that captures RGB color images, an RGB-IR camera, or the like. An imaging device included in the camera may be CMOS, CCD, or the like. The vehicle interior camera 5 may capture images of the windshield, the rear window, and/or side windows for the usage of detecting water droplets. The rear wiper driving device 6 includes an actuator for driving the rear wiper. The rear wiper driving device 6 drives the rear wiper on the basis of a control command transmitted from the wiper control device 10.

The wiper control device 10 has a controller 11 that controls the rear wiper. The controller 11 includes a computer having hardware and software, and this computer includes a ROM storing programs, a CPU executing the programs stored in the ROM, and a RAM functioning as an accessible storage device.

As illustrated in FIG. 1, the controller 11 is configured including an information obtaining unit 12, a water droplet determining unit 13, a line of sight determining unit 14, and a wiper control unit 15 as function blocks, and executes the respective functions by collaboration of the software and hardware for executing the respective functions. Note that, in this embodiment, the functions the controller 11 has are divided into four blocks, and descriptions of the functions of the respective function blocks are given, but the functions of the controller 11 are not necessarily divided into four blocks.

The information obtaining unit 12 obtains window information relating to the window glass of the vehicle 1 and the line of sight information of a driver. The information obtaining unit 12 obtains the window information from at least one of the devices among the windshield water droplet detecting device 2, the windshield wiper driving device 3, the rear window water droplet detecting device 4, and the vehicle interior camera 5. The window information is information relating to water droplets attached on the window glass. The window information is information for identifying whether water droplets are attached on a vehicle outer surface of the windshield and/or the rear window, an amount of the water droplets attached on the vehicle outer surface, and the like. The window information includes at least one of windshield wiper driving information indicative of a driving state of the windshield wipers, detected information by the windshield water droplet detecting device 2 (rain drop sensor) that detects the water droplets on the windshield, detected information by the rear window water droplet detecting device 4 (rain drop sensor) that detects the water droplets on the rear window, and a captured image of the window glass captured by the vehicle interior camera 5.

The information obtaining unit 12 obtains the windshield wiper driving information from the windshield wiper driving device 3. The windshield wiper driving information is indicative of on/off of the windshield wipers and a driving speed of the windshield wipers. The driving speed corresponds to a time per one reciprocation of the wiper. The detected information by the windshield water droplet detecting device 2 is indicative of an amount of the water droplets. The captured image of the window glass is used for identifying the water droplets in image processing. The information obtaining unit 12 performs image processing on the captured image of the driver, and obtains the line of sight information of the driver. The line of sight information of the driver is indicative of a line of sight of the driver, points of gaze, and the like. The line of sight information of the driver is used for determining whether the driver looks in the inside rear view mirror or not, and is used for operating the number of times the driver looks in the inside rear view mirror. Note that the inside rear view mirror is installed at a center position in the upper portion of the windshield. The inside rear view mirror is not limited to a mirror having a reflection function, and may be an electronic inside rear view mirror including a monitor (a display, such as a liquid crystal display, an organic EL display, or the like) that displays a captured image by a rear camera.

The water droplet determining unit 13 determines whether the water droplets are attached on the window glass on the basis of the window information. The water droplet determining unit 13 identifies an amount of the water droplets from the window information. The water droplet determining unit 13 determines that the water droplets are attached when the windshield wiper driving information indicates that the windshield wipers are on. The larger the driving speed or the faster the driving speed indicated by the windshield wiper driving information is, the larger the amount of the water droplets the water droplet determining unit 13 may identify. When the detected information by the windshield water droplet detecting device 2 and/or the rear window water droplet detecting device 4 is used, the water droplet determining unit 13 simply make a determination by the presence/absence of the water droplets and the amount of the water droplets indicated in the detected information. The water droplet determining unit 13 performs image processing on the captured image of the window glass, determines the presence/absence of the water droplets, and identifies the amount of the water droplets. For image processing, known image processing, such as binarizing or a background differencing technique, is simply used. The water droplet determining unit 13 determines whether the water droplets are attached on the window glass corresponding to whether water droplets on the glass surfaces are captured or not from the captured image of the window glass. The water droplet determining unit 13 identifies the amount of the water droplets captured on the glass surfaces as the amount of the water droplets. Note that the water droplet determining unit 13 is only necessary to perform a determination of whether the water droplets are attached on the window glass or not and an identification of the amount of the water droplets using at least one glass among the windshield, the rear window, and the side windows as a subject.

The line of sight determining unit 14 determines whether the driver looks in the inside rear view mirror or not on the basis of the line of sight information. The line of sight determining unit 14 operates the number of times the driver looks in the inside rear view mirror on the basis of the line of sight information. The line of sight determining unit 14 determines whether a line of sight of the driver is toward a position of the inside rear view mirror or not on the basis of the line of sight information. For example, the line of sight determining unit 14 identifies the line of sight of the driver from the line of sight information, and simply determines whether the inside rear view mirror is positioned on the extended line from the position of the driver's eyes along the line of sight. The line of sight determining unit 14 then determines that the driver looks in the inside rear view mirror when the line of sight of the driver is determined to be toward the position of the inside rear view mirror. Thus, the line of sight determining unit 14 determines whether the driver actually looks in the inside rear view mirror or not on the basis of the line of sight information.

The line of sight determining unit 14 may determine whether the driver looks in the inside rear view mirror or not on the basis of a moving direction of the line of sight of the driver. That is, when determining whether the driver looks in the inside rear view mirror or not, the line of sight determining unit 14 may determine that the driver looks in the inside rear view mirror when the driver looking in the inside rear view mirror is predictable, not limited to the driver actually looking in the inside rear view mirror. In other words, the line of sight determining unit 14 predicts the movement destination of the line of sight of the driver from the moving direction of the line of sight of the driver, and may determine that the driver looks in the inside rear view mirror before the driver actually looks in the inside rear view mirror when the inside rear view mirror is present at the movement destination.

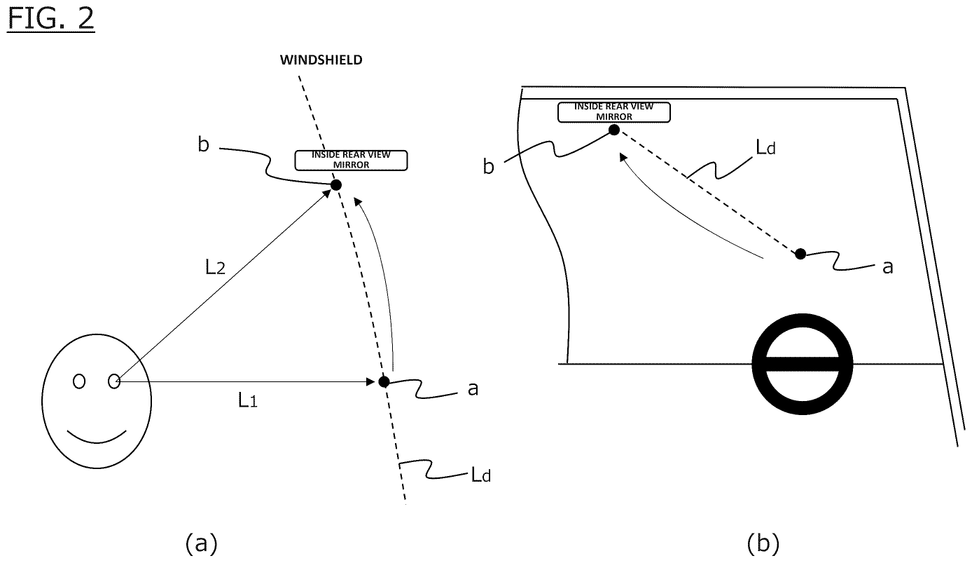

The line of sight determining unit 14 simply predicts the movement destination of the line of sight in the following manner. FIG. 2 is a schematic view for describing a method of predicting the movement destination of the line of sight. FIG. 2(a) is a schematic view for describing a positional relation between the driver and the windshield viewed from a side of the vehicle. The dotted line corresponds to a cross-sectional surface of the windshield. FIG. 2(b) is a drawing describing the line of sight of the driver when the windshield is viewed from the vehicle interior, and corresponds to an eyesight range of the driver when he/she looks ahead from the driver's seat. The line of sight determining unit 14 predicts the movement destination of the line of sight using line of sight tracking. The line of sight determining unit 14 identifies a line of sight reference line obtained by connecting the installation position of the inside rear view mirror to a predetermined reference position on the window glass. The predetermined reference position is a predetermined position on the windshield at the destination of the line of sight of the driver, and is set in advance. For example, when the vehicle travels in a straight line, and the driver looks ahead of the vehicle 1, the destination of the line of sight is at a position on the windshield with the driver's face looking ahead. The point a in FIG. 2 corresponds to the reference position (a “first position” of the present invention). The installation position of the inside rear view mirror on the window glass is a position on the windshield at the destination of the line of sight when the driver looks in the inside rear view mirror. The point b in FIG. 2 corresponds to the installation position of the inside rear view mirror (a “second position” of the present invention). The line of sight reference line represents the moving direction of the line of sight when the driver moves his/her line of sight toward the inside rear view mirror from the state where looking ahead of the vehicle 1. L_{d} in FIG. 2 represents the line of sight reference line.

The line of sight determining unit 14 identifies the moving direction of the line of sight of the driver on the basis of the line of sight information, and, when the identified moving direction is a direction along the line of sight reference line, determines that the driver looks in the inside rear view mirror. In the example in FIG. 2, the moving direction when the position on the windshield at the destination of the line of sight of the driver moves from the point a to the point b is the direction along the line of sight reference line. The line of sight determining unit 14 identifies the position on the windshield at the destination of the current line of sight of the driver (hereinafter also simply referred to as a viewpoint) on the basis of the line of sight information. The viewpoint is represented by a positional coordinate. The line of sight determining unit 14 operates a positional coordinate of the viewpoint identified last time and a moving amount of the positional coordinate identified this time. When the moving amount is equal to or more than a predetermined value, the line of sight determining unit 14 identifies the moving direction of the positional coordinate indicating the viewpoint. When the moving direction is the direction along the line of sight reference line, the line of sight determining unit 14 determines that the driver looks in the inside rear view mirror. The line of sight determining unit 14 can determine whether the driver looks in the inside rear view mirror or not when the driver's viewpoint starts to move before the driver's viewpoint actually moves from the point a to the point b illustrated in FIG. 2.

Note that various information of the line of sight reference line, the reference position, and the installation position of the inside rear view mirror is simply stored in advance in a memory or the like. The predetermined reference position may be a position of a side mirror, a position of a shift lever, a position of a hazard switch, or the like. For example, in a situation of changing traffic lanes, the driver confirms rearward with the side mirror and thereafter confirms rearward with the inside rear view mirror before moving to an adjacent lane. The line of sight of the driver at this time moves from the side mirror to the inside rear view mirror, therefore, the position of the side mirror is simply set in advance as the reference position. For example, in a situation of parking the vehicle by moving it backward, the driver operates the shift lever first, and looks in the inside rear view mirror after moving the gear to the reverse position. The line of sight of the driver at this time moves from the shift lever to the inside rear view mirror, therefore, the position of the shift lever is simply set in advance as the reference position. Similarly, in a situation of parking the vehicle by moving it backward, the driver may look in the inside rear view mirror after turning on the hazard switch, therefore, the position of the hazard switch is simply set in advance as the reference position.

The line of sight determining unit 14 operates the number of times the driver looks in the inside rear view mirror (hereinafter also simply referred to as “the number of looks”). The line of sight determining unit 14 determines whether the destination of the line of sight of the driver moves from the position of the inside rear view mirror or not after determining that the driver looks in the inside rear view mirror. After determining that the destination of the line of sight of the driver moves from the position of the inside rear view mirror, the line of sight determining unit 14 determines whether the driver looks in the inside rear view mirror or not on the basis of the moving direction of the line of sight of the driver in the same manner as above. The line of sight determining unit 14 repeats a sequence of these determination processes, and increments the number of looks at the timing at which the driver is determined to look in the inside rear view mirror. Note that the line of sight determining unit 14 may reset the number of looks when the driver is not determined to look in the inside rear view mirror for a certain period of time after the number of looks is incremented, that is, when the number of looks has no change. Thus, the line of sight determining unit 14 operates the number of looks per predetermined time.

The wiper control unit 15 controls the rear wiper on the basis of a determination result of the water droplet determining unit 13 and a determination result of the line of sight determining unit 14. The wiper control unit 15 outputs a control command to drive the rear wiper to the rear wiper driving device 6 when the water droplets are determined to be attached on the window glass, and the number of looks operated by the line of sight determining unit 14 is equal to or more than a predetermined count threshold. On the other hand, the wiper control unit 15 does not output the control command to drive the rear wiper to the rear wiper driving device 6 not to cause the rear wiper to be driven when the water droplets are not determined to be attached on the window glass, or the number of looks operated by the line of sight determining unit 14 is less than the predetermined count threshold. The count threshold is a natural number (an integer equal to or more than 1) and a value set corresponding to the amount of the water droplets by the wiper control unit 15.

The wiper control unit 15 sets the count threshold corresponding to the amount of the water droplets, The larger the amount of the water droplets is, the smaller the count threshold is set by the wiper control unit 15. Alternatively, the wiper control unit 15 sets the count threshold to a high value when the amount of the water droplets is equal to or less than a predetermined water droplet amount threshold value, and sets the count threshold to a low value when the amount of the water droplets is more than the water droplet amount threshold value. Note that the wiper control unit 15 may set the count threshold or the water droplet amount threshold value in multiple phases, not limited to two phases. Thus, when the amount of the water droplets is large, the rear wiper can be automatically driven when the driver looks in the inside rear view mirror for the less number of times than when the amount of the water droplets is small. Therefore, a burdensome control, for example, each one look in the inside rear view mirror always drives the rear wiper, for example, when a rainfall is small, is avoided, and when a rainfall is large, the rear wiper can be easily driven automatically. As the result, the rear wiper can be driven in line with an intention of the driver.

The wiper control unit 15 may determine a wiper driving frequency corresponding to the amount of the water droplets. The larger the amount of the water droplets is, the larger the wiper driving frequency is determined to be by the wiper control unit 15. Note that the driving frequency, for example, indicates the number of driving of the wiper per relatively long period of time, such as one driving (one cycle) per three minutes. The higher the wiper driving frequency is, the more the number of driving of the wiper per predetermined time becomes. The wiper control unit 15 includes determined driving frequency information in the control command and outputs it to the rear wiper driving device 6. The wiper control unit 15 may change the wiper driving frequency corresponding to the amount of the water droplets while the wiper is driven. The wiper control unit 15 may determine a rear wiper driving frequency before the driver enters the vehicle. The water droplet determining unit 13 identifies the amount of the water droplets from the window information while the vehicle is stopped without the driver in the vehicle. The wiper control unit 15 simply determines the wiper driving frequency corresponding to the amount of the water droplets while the vehicle is stopped without the driver in the vehicle.

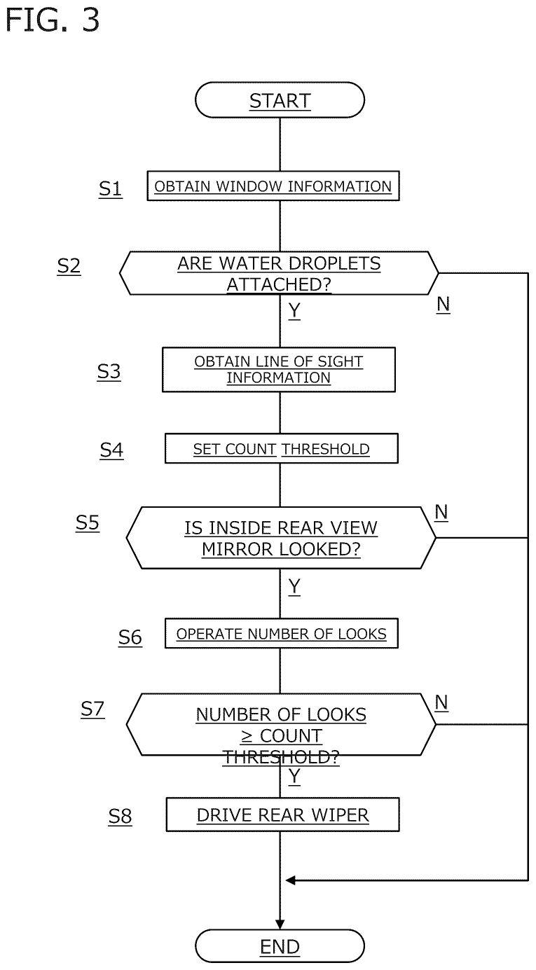

Next, using FIG. 3, a control procedure of the wiper control method executed by the controller 11 of the wiper control device 10 will be described. FIG. 3 is a flowchart showing an exemplary control procedure executing the wiper control method according to the embodiment. Not limited to while the vehicle 1 is stopped, the control flow in FIG. 3 can also be executed while the vehicle 1 is traveling. The control flow in FIG. 3 is repeatedly executed at a predetermined cycle. The control flow in FIG. 3 is not necessarily executed in the sequence shown in FIG. 3, or not all the steps are necessarily executed.

At Step S1, the information obtaining unit 12 of the controller 11 obtains window information from the windshield water droplet detecting device 2 or the like. At Step S2, the water droplet determining unit 13 determines whether water droplets are attached on a window glass or not on the basis of the window information. When the water droplets are attached on the window glass, the water droplet determining unit 13 identifies an amount of the water droplets. When the water droplets are not attached on the window glass, the controller 11 terminates the control flow shown in FIG. 3. At this time, when the rear wiper is driven, the controller 11 outputs a stop command to stop the driving of the rear wiper to the rear wiper driving device 6.

When the water droplets are determined to be attached on the window glass, at Step S3, the information obtaining unit 12 obtains line of sight information from the vehicle interior camera 5. Note that the step of obtaining the line of sight information may be performed before Step S2. At Step S4, the wiper control unit 15 sets a count threshold corresponding to the amount of the water droplets.

At Step S5, the line of sight determining unit 14 of the controller 11 determines whether the driver looks in the inside rear view mirror or not on the basis of the line of sight information. For the determination of whether the driver looks in the inside rear view mirror or not, the line of sight determining unit 14 may determine that the driver actually looks in the inside rear view mirror, or may determine that the driver looks in the inside rear view mirror from the prediction that the driver looks in the inside rear view mirror before the driver actually looks in the inside rear view mirror. When the driver is determined not to look in the inside rear view mirror, the controller 11 terminates the control flow shown in FIG. 3.

When the driver is determined to look in the inside rear view mirror, the line of sight determining unit 14 increments the number of looks to operate the number of looks. That is, the controller 11 continuously increases the number of looks by performing the process at Step S6 as the control flow in FIG. 3 is repeatedly executed.

At Step S7, the wiper control unit 15 compares the number of looks with the count threshold, and determines whether the number of looks is equal to or more than the count threshold or not. When the number of looks is less than the count threshold, the controller 11 terminates the control flow shown in FIG. 3. When the number of looks is equal to or more than the count threshold, the wiper control unit 15 outputs a drive command to drive the rear wiper to the rear wiper driving device 6. Then, the controller 11 terminates the control flow shown in FIG. 3.

As described above, the wiper control device 10 and the wiper control method according to the embodiment determines whether water droplets are attached on a window glass or not on the basis of window information, identifies an amount of the water droplets from the window information, operates the number of times a driver looks in an inside rear view mirror on the basis of line of sight information, sets a count threshold corresponding to the amount of the water droplets, and when the water droplets are determined to be attached on the window glass and the operated number of looks is equal to or more than the count threshold, outputs a control command to drive a rear wiper. This allows for driving the rear wiper in line with an intention of the driver. In addition, unnecessary rear wiper driving is reducible, thereby allowing the driver to be less bothered by the rear wiper blocking his/her eyesight. In addition, on a rainy day, without a manual operation, the driver can automatically drive the rear wiper when needed just by looking in the inside rear view mirror. Furthermore, corresponding to the rainfall, the rear wiper can be driven when needed, and therefore, unnecessary rear wiper driving is reducible, thereby allowing the driver to be less bothered by the rear wiper blocking his/her eyesight.

When the rainfall is small, for example, the driver may unintentionally look in the inside rear view mirror. Thus, the number of times the driver unintentionally looks in the inside rear view mirror in a situation of the small rainfall is once or a few times, and is a random number of times. In this embodiment, for example, when the amount of the water droplets is equal to or less than the water droplet amount threshold value, the controller 11 sets the count threshold to a low value. Thus, the rear wiper is not automatically driven even when the driver unintentionally looks in the inside rear view mirror in the situation where the rainfall is small. As the result, the rear wiper being automatically driven against the intention of the driver is avoidable.

In this embodiment, when the water droplets are determined to be attached on the window glass and the operated number is less than the count threshold, the control command to drive the rear wiper is not output. This allows for driving of the rear wiper when needed corresponding to the rainfall, and therefore, unnecessary rear wiper driving is reducible, thereby allowing the driver to be less bothered by the rear wiper blocking his/her eyesight.

In this embodiment, the driving frequency of the rear wiper is determined corresponding to the amount of the water droplets, and the control command including the driving frequency information is output. This allows for adjustment of the driving frequency of the rear wiper corresponding to the amount of the water droplets. In addition, the driving frequency of the rear wiper can be adaptively changed from input information to the controller 11, thereby allowing the driver to be less bothered and discomforted by the frequent automatic operation.

In this embodiment, the determination of whether the driver looks in the inside rear view mirror or not is performed by a determination of whether the line of sight of the driver is toward the position of the inside rear view mirror or not. Thus, whether the inside rear view mirror is looked in or not can be determined from the line of sight of the driver.

In this embodiment, the moving direction of the line of sight of the driver is identified from the line of sight information, when the identified moving direction is a direction along the predetermined line of sight reference line, the driver is determined to look in the inside rear view mirror. Note that the line of sight reference line is the line connecting the reference position to the installation position of the inside rear view mirror, the reference position is a predetermined reference position on the windshield at the destination of the line of sight of the driver, and the installation position of the inside rear view mirror is a position on the windshield at the destination of the line of sight when the driver looks in the inside rear view mirror. Thus, the movement destination of the line of sight of the driver is predicted from the moving direction of the line of sight of the driver, and whether the driver looks in the inside rear view mirror or not can be determined before the driver actually looks in the inside rear view mirror.

In this embodiment, the window information includes at least one of the windshield wiper driving information indicative of the driving state of the windshield wipers, the detected information by the rain drop sensor that detects the water droplets on the windshield, and the captured image of the window glass captured by the vehicle interior camera. Thus, the rain drop state is detectable even though a dedicated sensor for detecting the rain drop state of the rear window is not installed in the proximity of the rear window.

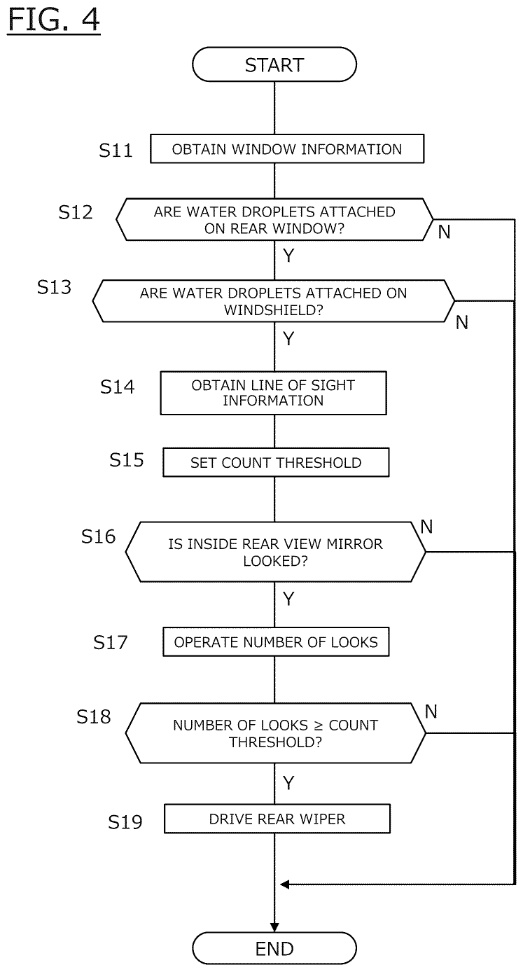

In a modification of this embodiment, the controller 11 may control the rear wiper by combining information on water droplets on the windshield and information on water droplets on the rear window. FIG. 3 is a flowchart showing an exemplary control procedure of executing a wiper control method according to the modification of this embodiment. Not limited to while the vehicle is stopped, the control flow in FIG. 4 can also be executed while the vehicle is traveling. The control flow in FIG. 4 is repeatedly executed at a predetermined cycle. The control flow in FIG. 4 is not necessarily executed in the sequence shown in FIG. 4, or not all the steps are necessarily executed.

The control flow at Step S11 is the same as the control flow at Step S1 in FIG. 3. At Step S12, the water droplet determining unit 13 of the controller 11 determines whether water droplets are attached on the windshield or not on the basis of the window information. The water droplet determining unit 13 determines whether the water droplets are attached on the windshield or not on the basis of at least one of the windshield wiper driving information obtained from the windshield wiper driving device 3, the detected information by the windshield water droplet detecting device 2, and the captured image of the windshield. When the water droplets are attached on the windshield, the water droplet determining unit 13 may identify an amount of the water droplets. When the water droplets are not attached on the windshield, the controller 11 terminates the control flow shown in FIG. 4.

When the water droplets are determined to be attached on the windshield, the water droplet determining unit 13 of the controller 11 determines whether the water droplets are attached on the rear window or not on the basis of the window information at Step S13. The water droplet determining unit 13 determines whether the water droplets are attached on the rear window or not on the basis of at least one of the detected information by the rear window water droplet detecting device 4 and the captured image of the rear window. When the water droplets are attached on the rear window, the water droplet determining unit 13 may identify an amount of the water droplets. When the water droplets are not attached on the rear window, the controller 11 terminates the control flow shown in FIG. 4.

When the water droplets are determined to be attached on both the windshield and the rear window, the controller 11 executes the control flows at Steps S14 to S19. The control flows at Steps S14 to S19 are the same as the control flows at Steps S3 to S8 in FIG. 3. However, in the control flow at Step S13, for the amount of the water droplets when the count threshold is set, at least any one of the amount of the water droplets on the windshield or the amount of the water droplets on the rear window may be used.

In the modification of this embodiment, the controller 11 may set the count threshold corresponding to a driving history of the rear wiper. For example, the controller 11 records a time point when the rear wiper has been driven last time (or a time point when the driving of the rear wiper has been stopped) as the driving history of the rear wiper to operate an elapsed time from the last driving of the rear wiper to now. Now it is a timing to start the control at Step S1 in FIG. 3, and is a timing at which, for example, a main switch (an ignition switch, a power switch of an electric vehicle, or the like) is turned on. When the elapsed time by now is less than a predetermined time threshold value, the controller 11 sets the count threshold to a high value. On the other hand, when the elapsed time by now is equal to or more than the predetermined time threshold value, the controller 11 sets the count threshold to a low value.

When the elapsed time from the time of the last driving of the rear wiper to now is short, rain drops on the rear window are wiped off by the last driving of the rear wiper, and therefore, an amount of the rain drops attached on the rear window is small, and a requirement degree of driving the rear wiper is highly possibly low. Therefore, in the modification, the shorter the elapsed time is, the higher value the count threshold is set to, and thus, frequent driving of the rear wiper is avoided. On the other hand, when the elapsed time is long, the count threshold is set to a low value, and the rear wiper is driven. Note that when the count threshold is set corresponding to the driving history of the rear wiper, it is preferred for controller 11 to add an element of the amount of the water droplets and set the count threshold.

In the modification of this embodiment, the controller 11 determines that water droplets are attached on at least any one of the glasses of the windshield and the rear window, and whether the windshield wipers are not moved on the basis of the window information. The controller 11 does not output a control command to drive the rear wiper when the water droplets are determined to be attached on at least any one of the glasses of the windshield and the rear window, and the windshield wipers are determined not to be moved. For example, when the water droplets are attached on at least any one of the glasses of the windshield and the rear window by a cause other than rain, such as when the vehicle is washed, and the windshield wipers are not moved, there is no necessity of driving the rear wiper. Therefore, in the modification, when the water droplets are attached on at least any one of the glasses of the windshield and the rear window with the windshield wipers not being moved, the rear wiper is not driven. Thus, for example, even when the driver looks in the inside rear view mirror while the vehicle is washed, erroneous driving of the rear wiper is avoidable.

Note that the driving frequency of the rear wiper and on and off of the wiper driving function are customizable by a user, and the operation control program can have its content updated not only by reading a solid-state memory element, such as a CD, a DVD, a Blu-ray Disc, or a flash memory, but also via a wireless communication, such as FOTA, OTA, or the like.

### Description of Reference Numerals

1 Vehicle
2 Windshield water droplet detecting device
3 Windshield wiper driving device
4 Rear window water droplet detecting device
5 Vehicle interior camera
6 Rear wiper driving device
10 Wiper control device
11 Controller
12 Information obtaining unit
13 Water droplet determining unit
14 Line of sight determining unit
15 Wiper control unit

1.-11. (canceled)

12. A wiper control device, comprising:
a controller for controlling a rear wiper, configured to:
obtain window information relating to a window glass of a vehicle;
obtain line of sight information of a driver;
determine whether water droplets are attached on the window glass or not based on the window information;
operate a count of times the driver looks in an inside rear view mirror based on the line of sight information; and
output, based on the count operated and the line of sight information, a control command to drive the rear wiper when the water droplets are determined to be attached on the window glass.

13. The wiper control device according to claim 12, wherein the controller is configured to:
identify an amount of the water droplets from the window information;
set a count threshold corresponding to the amount of the water droplets; and
output a control command to drive the rear wiper when the water droplets are determined to be attached on the window glass, and the count operated is equal to or more than the count threshold.

14. The wiper control device according to claim 12, wherein
the controller is configured not to output the control command when the water droplets are determined to be attached on the window glass, and the operated count is less than the count threshold.

15. The wiper control device according to claim 12, wherein
the controller is configured to:
determine a driving frequency of the rear wiper corresponding to the amount of the water droplets; and
output the control command including information of the driving frequency.

16. The wiper control device according to claim 14, wherein
the controller is configured to determine the driving frequency of the rear wiper before the driver enters the vehicle.

17. The wiper control device according to claim 12, wherein
the controller is configured to determine whether the driver looks in the inside rear view mirror or not by a determination of whether a line of sight of the driver is toward a position of the inside rear view mirror or not.

18. The wiper control device according to claim 12, wherein
the controller is configured to:
identify a moving direction of the line of sight of the driver from the line of sight information; and
determine that the driver looks in the inside rear view mirror when the moving direction is a direction along a predetermined line of sight reference line,
the line of sight reference line is a line that connects a first position to a second position,
the first position is a predetermined reference position on a windshield at a destination of the line of sight of the driver, and
the second position is a position on the windshield at a destination of the line of sight when the driver looks in the inside rear view mirror.

19. The wiper control device according to claim 18, wherein
the controller is configured to determine whether the driver looks in the inside rear view mirror or not based on the line of sight information before the driver actually looks in the inside rear view mirror.

20. The wiper control device according to claim 12, wherein
the window information includes at least one of windshield wiper driving information indicative of a driving state of windshield wipers, detected information by a rain drop sensor that detects rain drops on the windshield, and a captured image of the window glass captured by a vehicle interior camera.

21. The wiper control device according to claim 12, wherein
the controller is configured to determine that water droplets are attached on at least any one of the glasses of a windshield and a rear window, and whether windshield wipers are not moved, and not output the control command to drive the rear wiper when the water droplets are determined to be attached on at least any one of the glasses of the windshield and the rear window, and the windshield wipers are determined not to be moved.

22. The wiper control device according to claim 12, wherein
the controller configured to set the count threshold corresponding to a driving history of the rear wiper.

23. A wiper control method executed by a controller that controls a rear wiper, the method comprising:
obtaining window information relating to a window glass of a vehicle;
obtaining line of sight information of a driver;
determining whether water droplets are attached on the window glass or not based on the window information;
operating a count of times the driver looks in an inside rear view mirror based on the line of sight information; and
outputting, based on the count operated and the line of sight information, a control command to drive the rear wiper when the water droplets are determined to be attached on the window glass.
